(19) United States
(12) Patent Application Publication
(10) Pub. No.: US 2017/0292661 A1
(43) Pub. Date: Oct. 12, 2017

(54) MODULAR LIGHTING SYSTEM

(71) Applicant: ARTEMIDE S.p.A., Milano (IT)

(72) Inventors: Daniele Moioli, Milano (IT); Andrea Gallucci, Guanzate (IT); Paolo Leoni, Milano (IT)

(21) Appl. No.: 15/483,631

(22) Filed: Apr. 10, 2017

(30) Foreign Application Priority Data
Apr. 11, 2016 (IT) 202016000037051

(51) Int. Cl. F21S 2/00; F21V 15/01; F21V 21/005; F21S 4/28

(52) U.S. Cl. CPC F21S 2/005; F21S 4/28; F21V 15/01; F21V 21/005

(57) ABSTRACT

A modular lighting system comprises at least one module comprising a rail elongated longitudinally along an axis where one or more lighting elements are placed and mounted reversibly onto the rail by magnetic coupling, drawing power from a printed circuit board on the rail by means of spring contacts.

### PRIORITY CLAIM

This application claims priority from Italian Utility Model Application No. 202016000037051 filed on Apr. 11, 2016, the disclosure of which is incorporated by reference,

### TECHNICAL FIELD

The present innovation relates to a modular lighting system.

### BACKGROUND OF THE INVENTION

Modular lighting systems consisting of lighting modules that can be variously connected to each other in different spatial configurations are known.

However, in general, it seems that there is still room for improvement in the known modular lighting systems, particularly as regards their versatility, assembly and simplicity to make.

For example, most of the known modular systems only allow the various modules to be assembled in one or two directions, consequently making it possible to have final configurations, which are substantially linear or two-dimensional.

Furthermore, the known modular systems can, at times, present difficulties related to their assembly, also requiring the use of tools.

### SUMMARY OF THE INVENTION

It is therefore an object of the present invention to provide a modular lighting system,, which is particularly simple to make and assemble, and which offers a wide variety of different configurations, also three-dimensional (in other words extending not only in two directions but in three directions).

The present innovation therefore relates to a modular lighting system, as defined in basic terms in the accompanying claim 1 and, in its additional aspects, in the dependent claims.

### BRIEF DESCRIPTION OF THE DRAWINGS.

Further characteristics and advantages of the present innovation will become clear from the description of the following non-limiting embodiments, with reference to the accompanying drawings, wherein:

FIGS. 1 and 2 are two perspective schematic views, from above and from below, respectively, of a modular lighting system according to the invention, shown in an exemplary configuration;

FIG. 3 is a perspective view of a component of the modular system in FIG. 1, in particular a joint;

FIGS. 4 and 5 are a perspective view and a longitudinal section view, respectively, of a module of the modular lighting system in FIG. 1;

FIGS. 6 and 7 are two perspective schematic views of respective additional components of the modular lighting system in FIG. 1, in particular two differently shaped lighting elements;

FIGS. 8 and 9 are respective perspective schematic views of further configurations of the modular lighting system according to the invention.

### DETAILED DESCRIPTION OF THE INVENTION

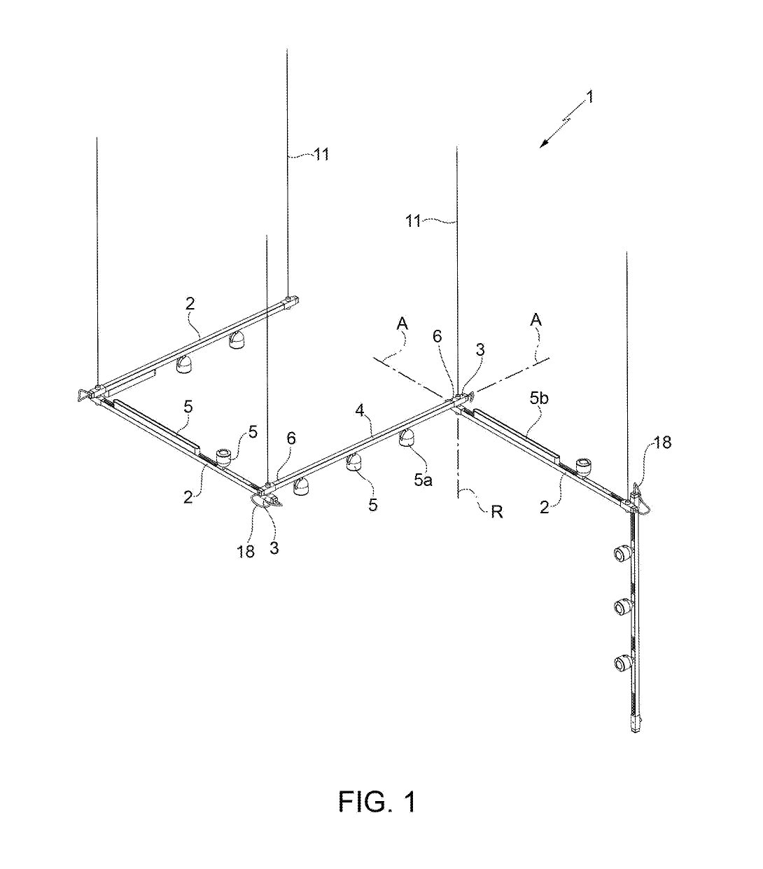

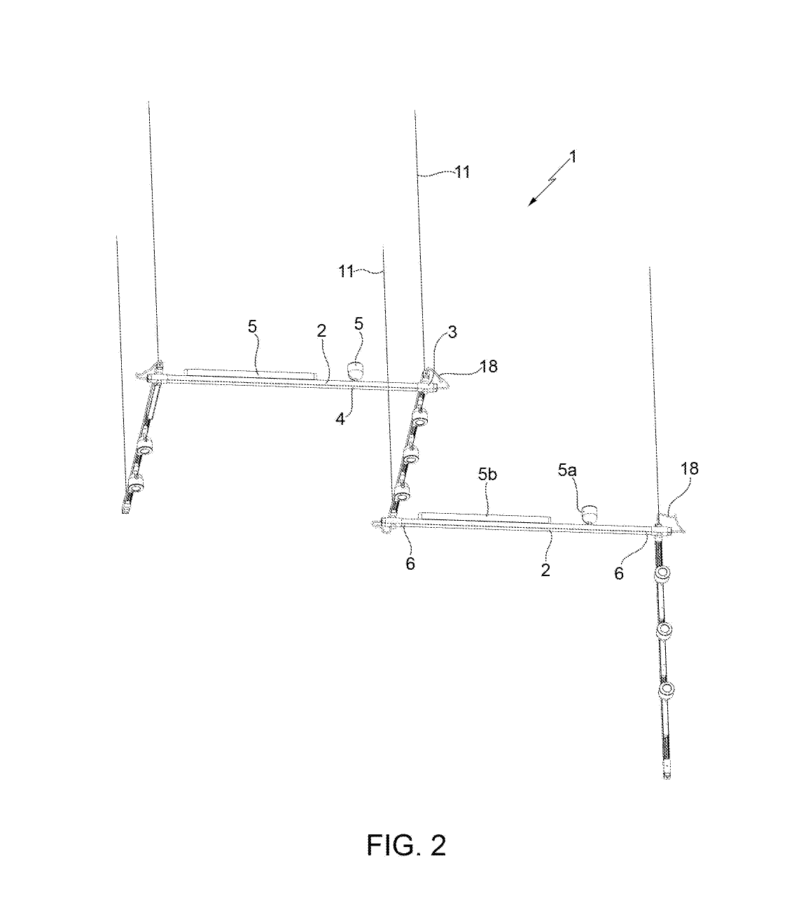

With reference to the FIGS. 1 and 2, a modular lighting system 1 comprises a plurality of combinable modules 2, joined by joints 3.

Each module 2 comprises a rail 4 elongated longitudinally along an axis A, where one or more lighting elements 5 are placed, which can be mounted reversibly onto the rail 4 by means of magnetic coupling. It is nonetheless understood that some rails 4 may also not include lighting elements 5.

The rails 4 extend along respective axes A between two opposite longitudinal ends 5 and are joined together by the joints 3.

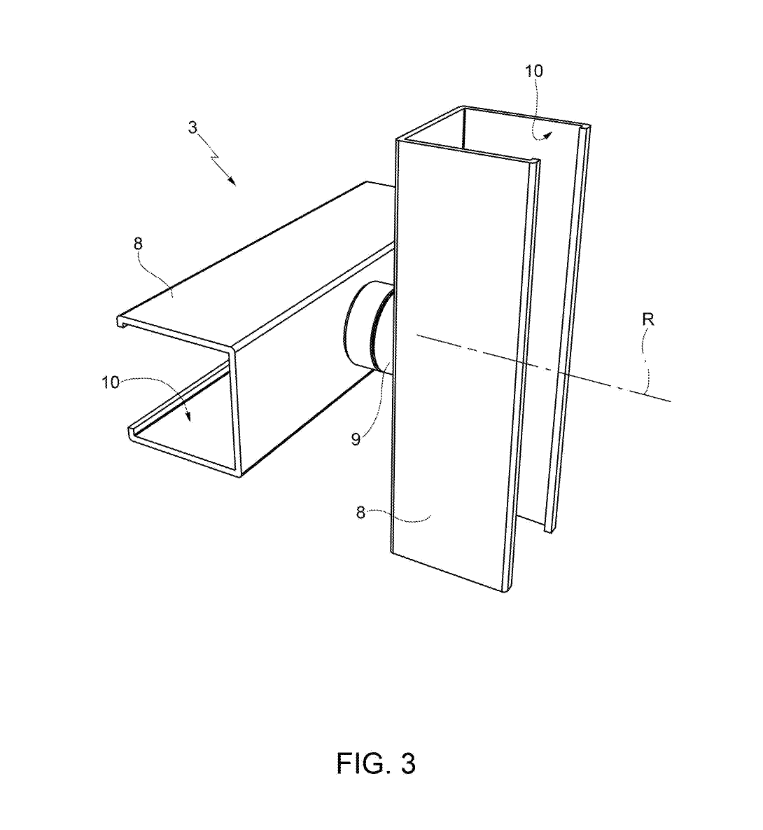

Also with reference to FIG. 3, each joint 3 joins two rails 4 and comprises two bodies 8 joined to each other by a pin 9 that allows the two bodies to rotate in relation to each other around a rotation axis R defined by the pin 9.

The rotation axis R of a joint 3, which joins a pair of rails 4, is perpendicular to the axes A of the rails 4 joined by the joint 3.

Each body 8 has a seat 10 adapted so as to receive a longitudinal end 6 of a rail 4, which can be inserted axially into the seat 10. Each body 8 can be mounted onto a rail 4 with at least two directions orthogonal to each other. In other words, the rail 4 can be inserted into the seat 10 in at least two different positions, rotated by 90° in relation to each other around the axis A of the rail.

The rail 4 is preferably shaped as a square cross section and the seats 10 also present a square cross section. In this way, the rail 4 can be inserted into the seat 10 with four different directions.

The rail 4 slides axially in the seat 10 and is constrained transversally in the seat 10.

The joints 3 can present an open cross section (as shown in FIG. 3) or closed (as shown in FIGS. 1 and 2),

As shown in FIGS. 1, 2, advantageously, the joints are also used to support the system 1, for example to suspend the system 1 to a ceiling, by means of suspension cables 11 fixed to respective upper closure portions of the joints 3.

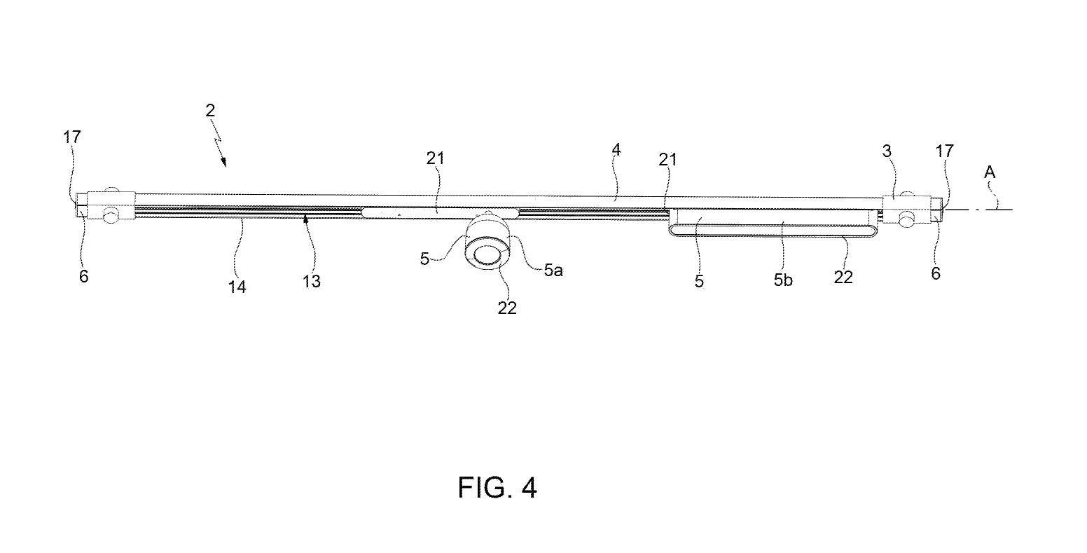

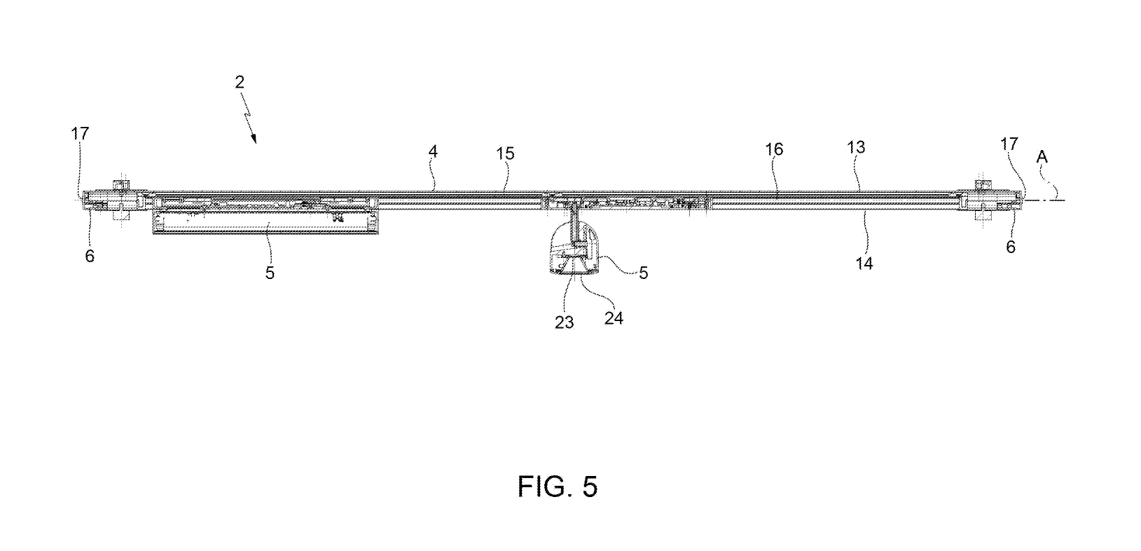

Also with reference to FIGS. 4 and 5, the rail 4 is shaped like a bar elongated longitudinally along the axis A.

As stated previously, the rail 4 has preferably a square shape in cross section.

The rail 4 is hollow internally and presents a longitudinal channel 13 having a front longitudinal aperture 14.

A back wall 15 of the channel 13, opposite the aperture 14, carries a printed circuit board 16 (PCB), which is arranged along the whole rail 4 and connected at the ends 6 of the rail 4 to respective terminals 17.

The printed circuit board 16 comprises conductor tracks, for example in copper, necessary for supplying and controlling the lighting elements 5, so as to allow electrification by contact of the lighting elements 5: the connection between each lighting element 5 and the printed circuit board 16 is magnetic thanks to the use of a magnetic material set behind the printed circuit board 16, and it can attract magnets, positioned on the lighting element 5.

Contact occurs and is guaranteed by spring contacts provided on the lighting elements 5, which draw power from the conductor tracks that run along the printed circuit board 16.

In this way, each lighting element 5 is connected to the rail 4 by magnetic coupling and an integrated electrical connection.

The conductor tracks are protected from oxidation thanks to a special conductive and protective finishing, made for example of graphite or galvanic gold-plating or other.

The system 1 can be supplied by an external power supply, or by a power supply that is mounted, in turn, onto

The electrical connection of the various modules 2 is guaranteed for example by connectors 18 (FIGS. 1, 2) that connect each pair of terminals 17 of modules 2 (in other words consecutive rails 4).

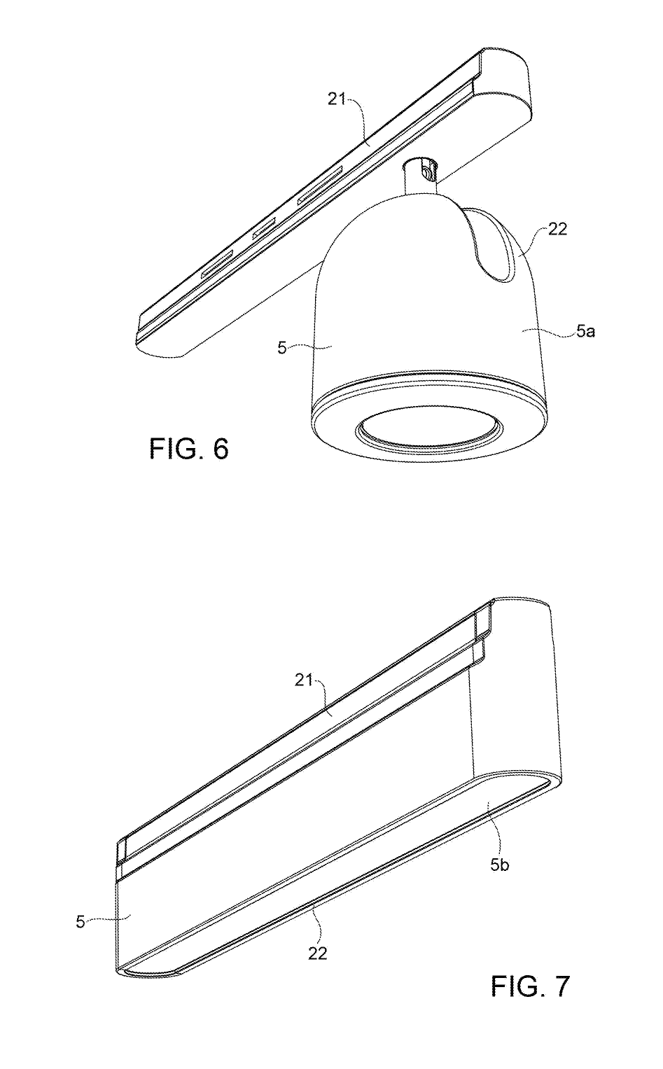

The system 1 can include different lighting elements 5. In the illustrated example, the system 1 comprises two types of lighting elements 5: an adjustable spotlight 5a (FIG. 6) and an elongated diffused light head 5b (FIG. 7). It is understood that other types of lighting elements 5 can be used, for example spotlights of different sizes and/or with different optical properties; diffused light heads of different lengths and/or shapes and/or with different emission characteristics; lighting elements of a completely different type; etc.

Each lighting element 5 comprises: a connection portion 21 that can be inserted into the channel 13 of a rail 4 through the aperture 14, which remains in use housed in the channel 13; and a lighting portion 22, which extends from the connection portion 21 and protrudes, in use, outside the channel 13.

The connection portion 21 carries the electrical contacts cooperating with the printed circuit board 16 of the rail 4 to supply the lighting element 5, and the magnets for the mechanical coupling of the lighting element 5 to the rail 4.

The lighting portion 22 comprises at least one light source 23 (FIG. 5), in particular a LED light source comprising one or mere LEDs, and an optical system 24 associated to the light source 23.

The lighting portion 22 is optionally connected to the connection portion 21 by an articulation (particularly in spotlight lighting elements 5).

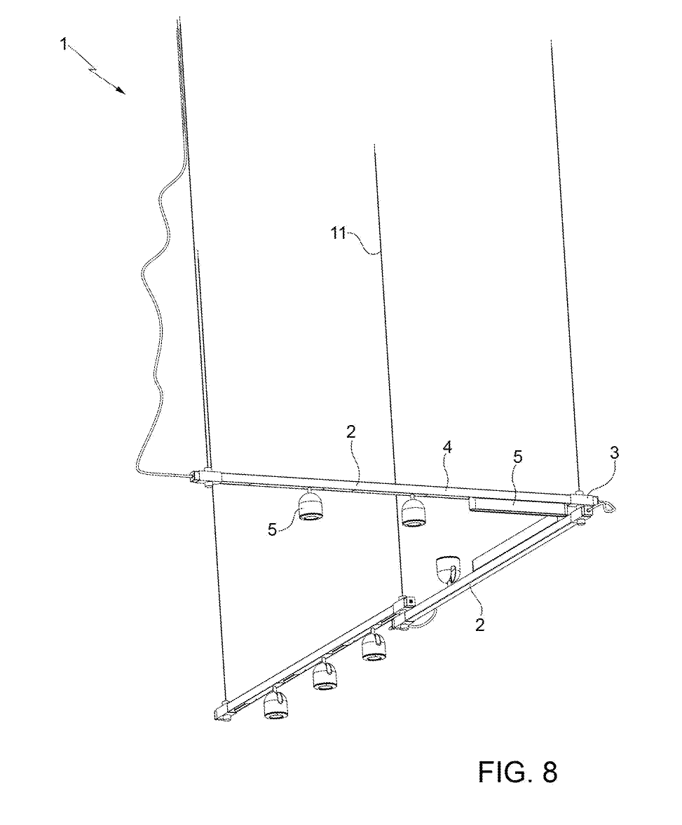

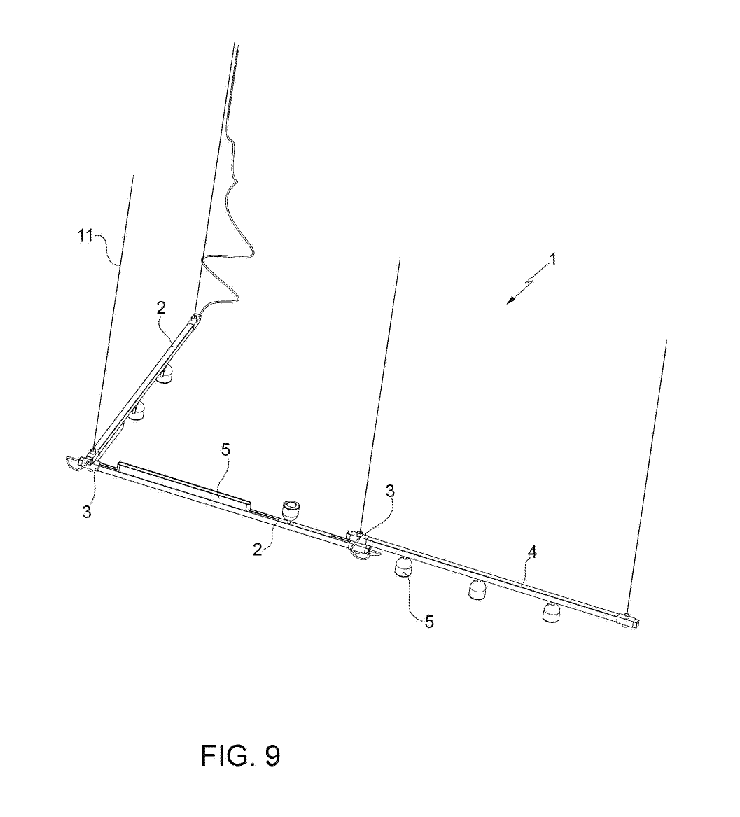

FIGS. 8 and 9 show further configurations, which can be adopted by the modular lighting system 1 of the invention.

It is clear from the illustrations and description that the system 1 can adopt multiple configurations. Starting with a few basic components (rails 4, joints 3, lighting elements 5), it is possible to create a system 1 of various shapes and sizes that is also three-dimensional.

Besides being able to mount the lighting elements 5 of a different type and required number onto each rail 4 and consequently onto each module 2, it is also possible to direct the lighting elements in four orthogonal directions, rotating the respective rail 4 in relation to the joints 3. The lighting elements 5 can therefore face upwards, downwards, to the right or to the left.

Furthermore, thanks to the joints 3, it is possible to connect the modules 2 with any angle: two modules 2 (in other words two rails 4) can be joined to each other with the respective axes A parallel, or perpendicular or in any case inclined. It is also possible to combine modules 2 both vertically and horizontally.

The system 1 can also include other types of accessory elements to be mounted onto the rails 4, advantageously again with magnetic coupling and integrated electrical connection by means of the printed circuit board 16: besides a power supply, as stated previously, and various types of lighting elements 5, the system 1 can include other accessory elements, such as sensors, command and interface elements, wireless connection elements, etc.

Finally, it is understood that further modifications and variations may be made to the modular lighting system described and illustrated here, which do not go beyond the scope of the accompanying claims.

1. A modular lighting system (1) comprising at least one module (2), comprising a rail (4) elongated longitudinally along an axis (A) where one or more lighting elements (5) are placed and mounted reversibly on the rail (4) by means of magnetic coupling, drawing power from a printed circuit board (16) positioned on the rail (4) by means of spring contacts.

2. The system according to claim 1, wherein the printed circuit board (16) comprises conductor tracks, behind which there is a magnetic material cooperating with magnets carried by the lighting elements (5).

3. The system according to claim 1, wherein the rail (4) is internally hollow and presents a longitudinal channel (13) having a front longitudinal aperture (14) and a back wall (15), opposite the aperture (14); the printed circuit board (16) being arranged along the whole rail (4) on said back wall (15) and being connected, at opposite longitudinal ends (6) of the rail (4), to respective terminals (17).

4. The system according to claim 3, wherein each lighting element (5) comprises; a connection portion (21), which can be inserted into the channel (13) of the rail (4) through the aperture (14) and which remains, in use, housed in the channel (13); and a lighting portion (22), which extends from the connection portion (21) and protrudes, in use, outside the channel (13).

5. The system according to claim 3, wherein the connection portion (21) carries the electrical contacts cooperating with the printed circuit board (16) of the rail (4) to supply the lighting element (5), and the magnets for mechanical coupling of the lighting element (5) to the rail (4).

6. The system according to claim 3, wherein the lighting portion (22) comprises at least one light source (23), in particular a LED light source comprising one or more LEDs, and an optical system (24) associated to the light source (23).

7. The system according to claim 1, wherein each lighting element (5) is provided with spring contacts protruding from a connection portion (21) of the lighting element (5) to contact the conductor tracks of the printed circuit board (16); and magnets, placed in the connection portion (21) to attract a magnetic material under the printed circuit board (16).

8. The system according to claim 1, and comprising a plurality of modules (2) joined by joints (3); and wherein each joint (3) joins two rails (4) and comprises two bodies (8) joined to each other by a pin (9), which allows the two bodies to rotate in relation to each other around a rotation axis (R) defined by the pin (9).

9. The system according to claim 8, wherein each body (8) has a seat (10) shaped so as to receive one longitudinal end (6) of a rail (4), which is insertable into the seat (10) with at least two directions that are orthogonal to each other, i.e. in at least two different positions rotated by 90° in relation to each other around the axis (A) of the rail (4).

10. The system according to claim 9, wherein the rail (4) is shaped in a square cross section and also the seats (10) have a square cross section.

11. The system according to claim 8, wherein the rotation axis (R) of a joint (3) which joins a pair of rails (4) is perpendicular to the axes (A) of the rails (4) joined by the joint (3).

12. The system according to claim 1, comprising at least two types of lighting elements (5) and specifically an adjustable spotlight (5a) and an elongated diffused light head (5b).

13. The system according to claim 1, comprising accessory elements to be mounted onto the rails (4), again with magnetic coupling and integrated electrical connection by means of the printed circuit board (16), such as a power supply, one or more sensors, control and interface elements, wireless connection elements, etc.
